(19) United States
(12) Patent Application Publication
(10) Pub. No.: US 2026/0103971 A1
(43) Pub. Date: Apr. 16, 2026

(54) METHOD FOR TREATING A GEOLOGICAL FORMATION

(71) Applicant: Swellfix UK Limited, Westhill, Aberdeenshire (GB)

(72) Inventors: Jonathan ABBOTT, Aberdeen (GB); Li JIANG, Katy, TX (US); Eilidh Jean MCKAY, Aberdeen (GB); Suzanne STEWART, Cypress, TX (US)

(73) Assignee: Swellfix UK Limited, Westhill, Aberdeenshire (GB)

(21) Appl. No.: 19/112,379

(22) PCT Filed: Jul. 5, 2024
(86) PCT No.: PCT/EP2024/069118

§ 371 Date: Mar. 17, 2025

(30) Foreign Application Priority Data
Jul. 7, 2023 (GB) 2310506.7
Jul. 7, 2023 (GB) 2310507.5
Jul. 7, 2023 (GB) 2310508.3

(51) Int. Cl. E21B 43/267; E21B 43/26

(52) U.S. Cl. CPC E21B 43/267; E21B 43/261

(57) ABSTRACT

A method for treating a geological formation surrounding a wellbore includes delivering a first media into the wellbore and into a fracture in the geological formation. The first media includes a plurality of swellable particulates configured to volumetrically swell in response to exposure to a swelling activator. The method includes delivering a second media into the wellbore and into the fracture in the geological formation, the second media being different to the first media and comprising a plurality of proppants. The first media is delivered ahead of the second media such that the swellable particulates are provided in a first region of the fracture towards a fracture tip and the proppants are provided in a second region of the fracture between the first region and the wellbore.

### FIELD

The present disclosure relates to a method for treating a geological formation.

### BACKGROUND

Subterranean formations may require stimulation techniques to be performed to improve the efficiency of an extraction process of a product in the formation, such as hydrocarbons or geothermal heat. For instance, in the case of hydrocarbon extraction, hydraulic fracturing processes may be performed to increase the flow of hydrocarbons into the wellbore. Hydraulic fracturing involves delivering a treatment fluid into the formation through the perforations of the wellbore at a certain pressure to create fractures in the formation improving the effective permeability and connectivity. Hydraulic fracturing processes can vary depending on certain factors, such as the formation type, extent of fracturing required, etc., but may generally comprise four stages: an acid stage, a pad stage, a proppant stage and a flush stage.

In the acid stage, water mixed with dilute acid is delivered into the wellbore to clear debris (e.g. cement debris) from the wellbore and to create a clear path into the formation. In the pad stage, fluid is delivered into the wellbore at a pressure sufficient to open the formation and create fractures. In the proppant stage, a carrier fluid mixed with proppant material is delivered into the fractures to “prop” open the fractures, thereby preventing the fractures from closing after the fluid pressure has been relieved. Lastly, in the flush stage, a fluid, usually water, is used to flush excess proppants and other debris out of the formation and wellbore, providing a clear path for hydrocarbons to flow to surface.

Operators may need to take into account a number of considerations when performing stimulation techniques. For example, it is common for oil and gas wells to be drilled in close proximity to one another, and stimulation techniques performed on one well may have a detrimental impact on neighbouring wells. Moreover, there may be zones adjacent the fracture comprising unwanted fluids (such as, water), which can undesirably migrate towards the fracture and mix with the flow of hydrocarbons being produced at surface.

### SUMMARY

An aspect of the present disclosure relates to a method for treating a geological formation surrounding a wellbore, the method comprising:
delivering a first media into the wellbore and into a fracture in the geological formation, the first media comprising a plurality of swellable particulates configured to volumetrically swell in response to exposure to a swelling activator; and
delivering a second media into the wellbore and into the fracture in the geological formation, the second media being different to the first media and comprising a plurality of proppants,
wherein the first media is delivered ahead of the second media such that the swellable particulates are provided in a first region of the fracture towards a fracture tip of the fracture, and the proppants are provided in a second region of the fracture between the first region and the wellbore.

The swellable particulates may volumetrically swell in the first region of the fracture towards the fracture tip, providing a number of preferential functions. For instance, when the swellable particulates are in a swelled condition they may create at least a partial fluid barrier or restriction in the first region. This may prevent or delay unwanted fluids (such as water, which has migrated from neighbouring zones in the formation) entering the fracture. Moreover, fracture growth during a hydraulic fracturing process may be dependent on many parameters, such as anisotropy of the formation, reservoir pore pressure, reservoir structure, etc. Therefore, the geometry of a fracture created during a hydraulic fracturing process can be difficult to predict and control. The swellable particulates in the first region of the fracture may exert a compressive force on the formation as the swellable particulates volumetrically swell, creating a region of localised stress around the fracture tip. Without wishing to be bound by theory, this region of localised stress in the formation may discourage other fractures from extending towards the fracture, thus reducing the likelihood of fractures from different wells connecting with one another. Moreover, this stress in the formation may be independent of pore pressure depletion, temperature or interaction with hydrocarbons and other fluids.

That is, the stress created by the volumetric swelling of the swellable particulates may compensate for a reduction in stress in the formation resulting from a drop in local pore pressure over time as the well is produced. In some instances, the swellable particulates, when in a swelled condition, may yield a local in-situ stress equal to or higher than a typical virgin stress (i.e. a natural stress existing in the geological formation before any artificial disturbance) at a range of depths for normal faulting conditions. Furthermore, since the swellable particulates are placed or deposited inside the fracture before closure and before swelling, the resulting stress under confined conditions after swelling may exceed and compensate for pore pressure depletion inside the fracture and surrounding matrix. This compensation may create a stress concentration at the fracture tip which may help maintain a stress shadow to divert fractures from other wells away from the fracture.

As used herein, a “fracture tip” may be a region of a fracture located furthest away from the wellbore. Moreover, the swellable particulates may be considered to be in a “swelled condition” when they have increased by at least 10% of their completely unswelled size.

At least one of the first and second media may be delivered into the wellbore at a pressure that exceeds a fracture pressure of the formation to create the fracture in the formation. Alternatively, the swellable particulates may be delivered into an existing fracture. The existing fracture may be a naturally existing fracture in the formation or a fracture created by a previous operation performed in the first zone.

The method may comprise delivering the first and second media into the wellbore in a number of operational stages. For example, the first media may be delivered into the wellbore in a first stage and the second media may be delivered into the wellbore in a subsequent second stage. Delivering the swellable particulates into the wellbore in first and second stages may allow for the swellable particulates to be provided at the fracture tip.

The first media and the second media may be delivered into the wellbore in a single, continuous operation. The second media may be delivered into the wellbore immediately after the first media is delivered into the wellbore.

The method may comprise flowing a formation product from the geological formation through the fracture towards the wellbore with the swellable particulates in the first region of the fracture, e.g. with the swellable particulates in a swelled condition. The method may comprise flowing the formation product from the geological formation through the fracture towards the wellbore with the proppants provided in the second region of the fracture.

The formation product may comprise a geothermal fluid. The geothermal fluid may have a higher temperature than a temperature of a region surrounding the wellbore.

The formation product may comprise hydrocarbons. The method may comprise flowing hydrocarbons from the geological formation into the wellbore via the fracture for production at surface. The method may comprise flowing hydrocarbons from the geological formation into the wellbore via the fracture for production at surface with the swellable particulates provided in the first region of the fracture, e.g. in a swelled condition. The method may comprise flowing hydrocarbons from the geological formation into the wellbore via the fracture for production at surface with the proppants provided in the second region of the fracture.

The proppants may be any suitable proppant known in the art, such as ceramics, sand, glass, plastics, etc. The proppants may be substantially non-swellable, e.g. completely non-swellable, or swellable to a negligible extent. The method may comprise forming a proppant matrix in the fracture, e.g. in the second region of the fracture between the first region and the wellbore. The method may comprise flowing the formation product through the proppant matrix with the swellable particulates provided in the first region of the fracture.

The method may comprise swelling the swellable particulates.

The swellable particulates may be configured to swell between 10% and 400% of their completely unswelled size, for example between 10% and 200% of their completely unswelled size, for example between 10% and 100% of their completely unswelled size.

The swelling activator may be any suitable activator. The swelling activator may be or comprise a fluid. The swelling activator may be or comprise water. The swelling activator may be or comprise a water-based fluid. The swelling activator may be or comprise an oil.

The swellable particulates may comprise a swellable material configured to volumetrically swell in response to exposure to the swelling activator.

The swellable particulates may be configured to absorb the swelling activator in order to volumetrically swell.

The swellable particulates may comprise at least one water swellable material. In this regard the swellable particulates may be defined as water swellable particulates.

The swellable particulates may be configured to swell by osmosis. In this regard the swellable particulates may be defined as osmotic swellable particulates. The swellable particulates may comprise a material having a composition such that permeation of the swelling activator (e.g. water) into the swellable particulates will occur as a result of osmosis.

The swellable particulates may comprise a polymer. The swellable particulates may comprise a rubber.

The swellable particulates may comprise a material configured to provide a desired swell strength, longevity under downhole conditions, and/or chemical resistance. The swellable particulates may be configured to swell under formation conditions, such as formation pressures and temperatures.

The swellable particulates may comprise a granular material. The swellable particulates may comprise a non-degradable material. The swellable particulates may comprise a material configured to be unreactive to certain substances. The certain substances may be substances that the swellable particulates may be expected to encounter during the operational lifetime of the swellable particulates. In other words, the swellable particulates may be configured to be substantially unaffected by exposure, i.e. not degrade when exposed, to such substances.

The swellable particulates may be configured to remain in the swelled condition for a required time duration, such as a perceived operational lifetime of the swellable particulates. The operational lifetime of the swellable particulates may be based on one or more factors, such as the expected operational lifetime of the well (e.g. from production to abandonment), the expected operational lifetime of a reservoir associated with the well, or the expected operational lifetime of a neighbouring well, etc. In this regard the swellable particulates may be considered as a permanent installation.

The swellable particulates may be configured for effective transport through the wellbore and into the fracture. For example, the swellable particulates may comprise a grain size distribution between 10 and 400 mesh, more preferably between 10 and 100 mesh, when in an unswelled condition. However, the size of the swellable particulates may vary depending on the application.

The mass of swellable particulates required for a particular operation, e.g. a hydraulic fracturing process, may vary depending on several factors, such as the formation type, extent of fracturing required, etc. However, a typical hydraulic fracturing process may require between 50 and 250 kg of the swellable particulates.

The first media may comprise a first carrier fluid. The first media may be provided by mixing the first carrier fluid with the swellable particulates, e.g. for subsequent delivery into the wellbore in a premixed state. Alternatively, the first media may be provided by flowing the first carrier fluid towards the wellbore and injecting or incorporating the swellable particulates into the first carrier fluid. The first media may comprise a mass of swellable particulates per volume of carrier fluid in a range of 1 kg/m³ to 800 kg/m³. However, this may vary depending on the application.

The first media may comprise fibre elements. The fibre elements may be mixed with the swellable particulates, e.g. before delivering the first media into the wellbore.

The fibre elements may be configured to create a web arrangement for constraining movement of the swellable particulates in response to exposure to an adhesion activator. The web arrangement created by the fibre elements may confine the swellable particulates to prevent the swellable particulates from moving to a more dispersed, relaxed position during and after the swelling process, thereby enhancing the fluid barrier created by the swellable particulates.

The web arrangement created by the fibre elements may comprise any shape or structure capable of constraining movement of the swellable particulates. The web arrangement created by the fibre elements may comprise an interconnected network of fibre elements. The web arrangement created by the fibre elements may comprise one or more groups or clusters of fibre elements. The size of the clusters may be controlled by adjusting a ratio (e.g. a stoichiometric ratio) of the swellable particulates to fibre elements.

The swelling activator and adhesion activator may comprise the same activator or different activators. Where the swelling activator and adhesion activator comprise different activators, this may allow for independent control of creation of the web arrangement and swelling of the swellable particulates.

The adhesion activator may be any suitable activator. The adhesion activator may be defined by a condition change, such as a change in temperature or pressure. The adhesion activator may comprise a fluid or chemical. In a preferred example, however, the adhesion activator is or is defined by an activation temperature.

A concentration or weight of the fibre elements may be based on a concentration or weight of the swellable particulates. For example, a weight of the fibre elements may be in a range from 0.5% to 10% of the total weight of swellable particulates.

The fibre elements may comprise or exhibit a selectively adhesive characteristic, e.g. a selectively tacky characteristic. The adhesive characteristic of the fibre elements may be temperature or chemically activated. The fibre elements may be configured not to adhere to one another and/or the swellable particulates until the fibre elements have been temperature or chemically activated. In one preferred example, the adhesive characteristic of the fibre elements is temperature activated at a temperature in a range between 60 to 200 degrees Celsius. The fibre elements may comprise or be similar to fibre elements described in WO 2010/075248 A1, which is incorporated herein by reference.

Alternatively or additionally, the swellable particulates may be configured to adhere to one another after absorbing the swelling activator. The swellable particulates may be configured to exhibit or comprise an adhesive characteristic (e.g. a tacky characteristic) after absorbing the swelling activator. Where the swellable particulates comprise water swellable particulates, and have absorbed the swelling activator (i.e. water), the swellable particulates may be configured to adhere to one another by virtue of a hydrogen bond (H-bond) between adjacent swellable particulates. In this respect a hydrogen bond (H-bond) network may be formed by the swellable particulates. The swellable particulates may be configured to form clusters with one another after absorbing the swelling activator.

The fibre elements may be configured to withstand exposure to certain substances that the fibre elements may encounter during their operational lifetime, including expected downhole pressures, temperatures, reservoir fluids and chemicals used during typical stimulation operations.

The fibre elements may be configured to degrade upon exposure to a degrading agent. The degrading agent may comprise one or more additives or chemicals. This may provide for the web arrangement created by the fibre elements to be reversed upon delivery of the degrading agent to the fibre elements in the fracture.

The fibre elements may be configured to be substantially non-swellable, i.e. completely non-swellable or swellable to a negligible extent.

The fibre elements may comprise various sizes. The fibre elements may comprise a variety of cross-sectional shapes, e.g. circular, prismatic, cylindrical, lobed, rectangular or polygonal. The fibre elements may comprise a straight profile or an undulating profile.

The fibre elements may be configured to provide a large surface area relative to a volume of the fibre elements. The fibre elements may comprise an aspect ratio of at least 2:1, for example 10:1, 100:1, 1000:1, etc. Larger aspect ratios (e.g., having aspect ratios of 10:1 or more) may help promote the formation of a network of the fibre elements, as well as allowing for more swellable particulates to adhere to external surfaces of the fibre elements.

The fibre elements may have a length in a range of 2 to 60 mm. The fibre elements may comprise a cross-sectional dimension of up to 500 micrometres.

The fibre elements may comprise one or more additives and/or coatings, for example to impart desirable properties such as handling, processability, stability and dispersibility.

The fibres elements may comprise one or more surfactants, e.g. emulsifiers. The surfactants may be configured to improve the dispersibility or handling of the fibre elements. In some examples, the surfactants may be added to the fibre elements in a range of 0.05 to 3 percent by weight of the fibre elements.

The fibres elements may comprise one or more polymeric dispersing agents. The polymeric dispersing agents may be configured to promote the dispersion of the fibre elements in a chosen medium and at desired application conditions (e.g., extreme pH and/or elevated temperatures). In some examples, the polymeric dispersing agents may be added to the fibre elements in a range of 0.05 to 5 percent by weight of the fibre elements.

The fibres elements may comprise one or more antioxidants. The antioxidants may be configured to retain useful properties of the fibre elements through their operational life. In some examples, the antioxidants may be added to the fibre elements in a range of 0.05 to 1.5 percent by weight of the fibre elements.

The fibres elements may comprise one or more of colorants (e.g. dyes and pigments), fillers (e.g. carbon black, clays, and silica) and surface applied materials (e.g. waxes, talcs, erucamide, gums, and flow control agents), for example to help improve storage, transportation and handling.

The fibre elements may comprise a core-shell configuration.

The core may be configured to provide rigidity. The shell may be configured to comprise or exhibit the adhesive characteristic of the fibre elements referred to hereinabove.

The shell may comprise a polymeric material or a blend of polymeric materials. The shell may comprise one or more other additives, e.g. a plasticizer, a superabsorbent polymeric material, etc. The shell may comprise at least one of a thermoplastic composition and a curable resin. The shell may comprise or be formed of an ethylene acid copolymer, which may be partially neutralized. In some examples, the shell may comprise or be formed of a product sold under the trade name SURLYN™ Ionomers sold by DOW, such as SURLYN™ 1605 lonomers or SURLYN™ 1702 Ionomers. The shell may comprise a softening point. A softening temperature of the shell may be configured to be slightly greater than an anticipated temperature of the reservoir zone to be treated. The desired softening temperature can be achieved by selecting an appropriate single polymeric material or combining two or more polymeric materials. Exemplary polymeric materials may have or may be modified to have a softening temperature in the range of 60 to 150 degrees Celsius.

The fibre elements may be configured to bond without significant loss of their core-shell configuration or shape. The fibre elements may be configured to maintain a spatial relationship of the core and shell after the adhesive characteristic of the fibre elements has been activated.

In some examples, the shell may comprise an elastic modulus of less than 3×10⁵ N/m² at a frequency of about 1 Hz at a temperature of at least 60 degrees Celsius.

The core may comprise blends of polymers and/or other components. The core may have a melting point at a temperature in a range of 130 and 220 degrees Celsius. The core may comprise at least one of a thermoplastic composition and a curable resin. In some examples, the core may comprise or be formed of a nylon, such as Nylon66.

The fibre elements may be formed using techniques known in the art for making core-shell fibres, such as fibre spinning. The fibre elements may be crosslinked, for example through radiation or chemical means.

The second media may comprise a second carrier fluid. The second media may be provided by mixing the second carrier fluid with the proppants, e.g. for subsequent delivery into the wellbore in a premixed state. Alternatively, the second media may be provided by flowing the second carrier fluid towards the wellbore and injecting or incorporating the proppants into the second carrier fluid.

The second media may be absent or substantially absent of swellable particulates, e.g. completely absent of swellable particulates, or comprising a negligible amount of swellable particulates.

At least one of the first and second media may comprise a filler material. The filler material may be or comprise sand (for example, a fine mesh sand), glass, etc. For example, the first media may comprise a filler material. The filler material may be configured to occupy a portion of the first region of the fracture. In this regard the method may comprise providing the swellable particulates and the filler material in the first region of the fracture. The filler material may reduce the mass of swellable particulates required to perform a particular treatment process. The swellable particulates may be configured to swell against or around the filler material. At least one of the filler material and swellable particulates may be configured to be at least partially deformable, e.g. when engaged with one another.

The first and second carrier fluids may be or comprise the same fluid. The first and second carrier fluids may be or comprise different fluids.

At least one of the first and second carrier fluids may be configured to limit or prevent swelling of the swellable particulates, e.g. as the swellable particulates are transported through the wellbore and into the geological formation. In particular, where the swellable particulates are water swellable particulates, at least one of the first and second carrier fluids may comprise a saline solution, e.g., a high-salinity brine or other solvent. This may allow for swelling of the swellable particulates to be delayed until the swellable particulates are delivered into the fracture.

The rate of swelling may be modulated by manipulating an osmotic pressure differential across an interface between the swellable particulates and the carrier fluid, thus a rate of fluid penetrating into the swellable particulates can be controlled. This may allow for the rate at which the swellable particulates swell to be substantially reduced as the swellable particulates are transported through the wellbore and into the fracture.

The first and second carrier fluids may be any suitable fluid. At least one of the first and second carrier fluids may be a fluid used in a hydraulic fracturing process. At least one of the first and second carrier fluids may comprise one or more additives. For example, at least one of the first and second carrier fluids may comprise a viscosity agent, such as a thickener, to assist with suspending the swellable particulates and/or proppants in the carrier fluids. At least one of the first and second carrier fluids may comprise one or more surfactants. At least one of the first and second carrier fluids may be or comprise water. At least one of the first and second carrier fluids may be or comprise a water-based fluid.

Where the first and second carrier fluids comprise the same carrier fluid, the method may comprise delivering (e.g. pumping) carrier fluid into the wellbore. The method may comprise injecting or incorporating swellable particulates into the carrier fluid as the carrier fluid flows towards the wellbore and subsequently injecting or incorporating the proppants into the carrier fluid as the carrier fluid flows towards the wellbore.

The method may comprise flowing or displacing at least one of the first and second carrier fluids from the fracture, e.g. back into the wellbore. For instance, at least one of the first and second carrier fluids may flow or be displaced by reducing a pressure of the carrier fluid, e.g. from surface. Alternatively, or in addition, a natural pressure of the formation may act on at least one of the first and second carrier fluids to force the at least one of the first and second carrier fluids out of the fracture.

The method may comprise chasing or over-flushing at least one of the first and second carrier fluids using a chaser fluid, e.g. which may be delivered into the wellbore after the first and second media have been delivered into the wellbore. This may force the at least one of the first and second carrier fluids to be displaced from the fracture further into the formation, which may help accelerate in-situ swelling of the swellable particulates in the first region of the fracture.

The method may comprise retaining the swellable particulates in the first region of the fracture while flowing or displacing the first and second carrier fluids from the fracture. The method may comprise retaining the proppants in the second region of the fracture while displacing the first and second carrier fluids from the fracture. The method may comprise engaging the swellable particulates with a wall of the fracture. The method may comprise engaging the proppants with a wall of the fracture. In this regard friction between at least one of the swellable particulates and proppants with the fracture wall may prevent the swellable particulates and proppants from flowing out of the fracture as the first and second carrier fluids flow out of the fracture.

In some examples, certain processes may not be performed on the wellbore that would compromise or degrade the swellable particulates. For example, processes involving substances that may degrade the swellable particulates may not be performed without appropriate steps being taken, such as isolating the fracture from a part of the wellbore subject to the process.

Certain aspects or properties of the swellable particulates and/or proppants may assist with reducing the likelihood of the swellable particulates and proppants intermingling as the first and second media are transported through the wellbore and into the fracture. The swellable particulates may be dimensioned based on a dimension of the proppants to reduce the likelihood of the swellable particulates and proppants mixing with one another. In particular, the swellable particulates may comprise a size or shape for reducing the likelihood of mixing with the proppants. For example, the swellable particulates may comprise a different size or shape than the proppants. Preferably, the individual swellable particulates (at least when in an unswelled condition) may be smaller in size than the individual proppants. The swellable particulates may comprise one or more of a sphere, flake, cylinder, star, cube, etc. The swellable particulates may comprise the same size and shape, or different sizes and shapes. A density of swellable particulates in the carrier fluid may be more or less than a density of the proppants in the carrier fluid. A concentration of swellable particulates in the first carrier fluid may be more or less than a concentration of the proppants in the second carrier fluid. Where the first and second carrier fluids are different fluids, the first and second carrier fluids may be substantially immiscible. This may help mitigate mixing of the swellable particulates and proppants.

The method may comprise forming a bridge with at least a portion of swellable particulates at the fracture tip. Bridging is a phenomenon which occurs where particulates of a certain size simultaneously arrive at a constriction in a flow path and form a bridge or arch across the constriction, thereby obstructing the flow path and preventing further particulates from travelling past the constriction. Bridging is dependent on parameters including the size ratio between the particulates and the constriction, the concentration of particles, the carrier fluid viscosity, the presence of other solid additives and a flow velocity of the particulates.

The fracture may vary in cross-sectional area along a length of the fracture. The facture tip may have a smaller cross-sectional area than a main body of the fracture. The swellable particulates may be configured to bridge with one another at the fracture tip, for example at a distance from an outermost point of the fracture. As such, the method may comprise providing the swellable particulates with a certain size based on at least one of formation pore dimensions and expected fracture dimensions (which, for example, may be obtained by performing hydraulic fracturing simulations). The swellable particulates may comprise a certain shape, size and/or size distribution so that the swellable particulates bridge with one another at the fracture tip. The method may comprise delivering the swellable particulates into the fracture at a certain flowrate in a carrier fluid optimised to encourage bridging of the swellable particulates at the fracture tip.

The second media may be delivered into the wellbore a certain time after the first media is delivered into the wellbore. For example, the method may comprise delivering a buffer fluid into the wellbore intermediate the first and second media. The buffer fluid may function to maintain the first media separate from the second media. This may further encourage the swellable particulates to travel to the fracture tip ahead of the proppants. The buffer fluid may comprise any suitable fluid, such as oil, water, slick water, fracturing fluid, etc. The buffer fluid may be or comprise the same fluid as at least one of the first and second carrier fluids. The buffer fluid may be or comprise a different fluid than at least one of the first and second carrier fluids. The buffer fluid may be configured to be substantially immiscible with at least one of the first and second carrier fluids.

The first media may be delivered into the wellbore by pumping the first media into the wellbore. The second media may be delivered into the wellbore by pumping the second media into the wellbore.

The first media may be delivered into the wellbore at a first pressure. The second media may be delivered into the wellbore at a second pressure. The first and second pressures may be the same. The first and second pressures may be different.

The first media may be delivered into the wellbore at a first flowrate. The second media may be delivered into the wellbore at a second flowrate. The first and second flowrates may be the same. The first and second flowrates may be the different.

The pressure and/or flowrate of the second media may have an effect on the pressure and/or flowrate of the first media as the first and second media are transported through the wellbore and into the fracture, e.g. the pressure and/or flowrate of the second media may be imparted onto the first media. For instance, the first media may be delivered into the wellbore at a pressure below a fracture pressure of the formation. The second media may be delivered into the wellbore at a pressure that exceeds the fracture pressure. The pressure of the second media may be imparted onto the first media to allow the first and second media to create the fracture, while delivering the first media into the fracture ahead of the second media.

At least one of the first and second media may comprise the swelling activator. At least one of the first and second carrier fluids may comprise the swelling activator. In this regard the swellable particulates may partially swell as the first and second media are transported through the wellbore and into the fracture. The method may comprise retaining at least one of the first and second carrier fluids in the fracture for a certain duration of time to achieve a desired amount of swelling. The method may comprise delivering an additional amount of at least one of the first and second carrier fluids (when comprising the swelling activator) into the wellbore and into the fracture after the swellable particulates have been provided in the first region of the fracture and the proppants have been provided in the second region of the fracture to achieve a desired amount of swelling of the swellable particulates.

Alternatively or additionally, the buffer fluid may comprise the swelling activator. Alternatively or additionally, the chaser fluid may comprise the swelling activator.

At least one of the first and second media may be delivered into the wellbore as part of a hydraulic fracturing process. In particular, the first and second media may be delivered into the wellbore at any stage in a hydraulic fracturing process. For example, the first media may be delivered into the wellbore prior to or during the early stages of a hydraulic fracturing process. The first media may be delivered into the wellbore as, or as part of, a preliminary injection test. The preliminary injection test may be performed before a pad stage and before, or after, an acid stage in a hydraulic fracturing process. The second media may be delivered into the wellbore during a proppant stage in a hydraulic fracturing process. Alternatively, or in addition, the first media may be delivered into the wellbore as, or as part of, a pad stage in a hydraulic fracturing process. Alternatively, or in addition, the first media may be delivered into the wellbore at the onset of a proppant stage in a hydraulic fracturing process, with the second media being delivered into the wellbore immediately after.

The swelling particulates may comprise a coating. The coating may be configured to degrade after a certain duration of time. The coating may be configured to degrade when exposed to a certain amount of a degrading agent. The degrading agent may be the same as the swelling activator. The degrading agent may be the same composition as the swelling activator. The coating may be configured to degrade at a predetermined point in a treatment process, e.g. in a hydraulic fracturing process. The coating may be configured to degrade when the swellable particulates have been provided in the first region of the fracture. This may prevent premature swelling of the swellable particulates (i.e. swelling to an undesirable extent) prior to reaching the fracture tip, which may otherwise inhibit the flow of the treatment fluid through the wellbore and into the fracture. The coating may comprise a material with a low molecular weight, such as a mineral oil. The coating may comprise a molecular weight in a range of 100 to 500 Da, preferably in a range of 125 to 400 Da and more preferably in a range of 150 to 300 Da. A material with a low molecular weight may form a temporary barrier between the swellable particulates and the swelling activator, and may eventually give way under shear and increasing temperatures.

The swellable particulates may be configured to swell at a certain swell rate, for example when exposed to the swelling activator. The swell rate of the swellable particulates may be configured to provide the swellable particulates in a swelled condition after a certain duration of time, or at a certain point in the method, e.g. when provided in the first region of the fracture. The swell rate of the swellable particulates may prevent premature swelling of the swellable particulates (i.e. swelling to an undesirable extent) prior to reaching the fracture tip.

The first and second media may be delivered into the wellbore without any swelling activator.

The method may comprise exposing the swellable particulates to the swelling activator after the swellable particulates have been provided in the first region of the fracture.

The method may comprise delivering the swelling activator into the wellbore after the first and second media have been delivered into the wellbore. The method may comprise delivering the swelling activator into the wellbore after the first and second carrier fluids have flowed or been displaced from the fracture. The method may comprise delivering the swelling activator into the wellbore as, or as part of, a flush stage in a hydraulic fracturing treatment. Where the swellable particulates are water swellable particulates, the flush stage may comprise delivering a diluted or low-salinity solution, such as water, into the wellbore and into the fracture to cause swelling of the swellable particulates.

The method may comprise utilising a swelling activator existing in the formation and exposing the swellable particulates to the swelling activator when provided at the fracture tip.

The method may comprise diverting the first and second media from the wellbore into the formation. The method may comprise setting a plug or diverter at a suitable location in the wellbore to direct the first and second media through a perforation of the wellbore and into the fracture.

The method may comprise monitoring parameters of the first and second media, for example a pressure and flowrate of the first and second media. The method may comprise monitoring for a parameter change and associating the change with the creation of a fracture in the formation. For example, the parameter change may comprise a pressure drop or an increase in flowrate of the first and second media.

In some examples, prior to performing the first step of delivering the first media into the wellbore, the method may comprise delivering a third media into an adjacent fracture in the geological formation. The adjacent fracture may be located in a first zone adjacent to a second zone, wherein the second zone contains the fracture referred to above in which the first and second media are delivered.

In some examples, the first zone may be associated with a region of the geological formation that has been depleted and is producing unwanted fluids, such as water or gas. The second zone may be associated with a region of the geological formation containing hydrocarbons. The first zone may be a lower zone and the second zone may be an upper zone, or vice versa.

In some examples, the first zone may be located closer to the surface than the second zone. The fluid barrier or restriction provided by the swellable particulates in the first zone may reduce or prevent fluids (such as, carbon dioxide) from entering the first zone and migrating towards the surface.

The third media may comprise a plurality of swellable particulates configured to volumetrically swell in response to exposure to a swelling activator. The swellable particulates of the third media may comprise the same type of swellable particulates as the first media. The swellable particulates of the third media may comprise a different type of swellable particulates to the swellable particulates of the first media. The swelling activator may be or comprise the same swelling activator as the swelling activator used to swell the swellable particulates of the first media. The swelling activator may be or comprise a different swelling activator to the swelling activator used to swell the swellable particulates of the first media. The third media may comprise a third carrier fluid. The third carrier fluid may comprise the same fluid as the first and/or second carrier fluids or a different fluid than the first and/or second carrier fluids.

It may be desirable to isolate the first (depleted) zone and to perform a stimulation technique, such as the method described hereinabove, on the second zone. However, in this scenario, there may be a risk that a new fracture created in the second zone will grow into the first zone due to the lower reservoir pressure and in-situ stress of the first zone. Thus, delivering the third media into the adjacent fracture may provide for a number of preferential functions. For instance, the swellable particulates may exert a compressive force on the formation as the swellable particulates volumetrically swell, creating a region of localised stress around the first zone. This stress concentration around the first zone may function to discourage fractures created in the second zone from extending towards the first zone. Further, the swellable particulates may function to create at least a partial fluid barrier or restriction around the first zone, which may prevent or delay unwanted fluids, such as water or gas, from entering the second zone.

The third media may be delivered into the wellbore at a pressure that exceeds a fracture pressure of the formation to create a new fracture in the second zone of the geological formation. Alternatively, the third media may be delivered into an existing fracture in the second zone.

The method may comprise setting a first plug or diverter at a first location in the wellbore to direct the third media into the first fracture in the first zone of the geological formation. The method may comprise subsequently setting a second plug or diverter at second location in the wellbore to direct the first and second media into the second fracture in the second zone of the geological formation.

In this example where the third media is delivered into the geological formation prior to the first and second media, the first and second media may be referred to as second and third media, respectively, while the third media may be referred to as the first media.

Another aspect of the present disclosure relates to a method for creating a fluid barrier or restriction in a geological formation, the method comprising:
delivering a first media into the wellbore and into a fracture in the geological formation, the first media comprising a plurality of swellable particulates comprising a swellable material configured to volumetrically swell in response to exposure to a swelling activator;
delivering a second media into the wellbore and into the fracture in the geological formation, the second media being different to the first media and comprising a plurality of proppants,
wherein the first media is delivered ahead of the second media such that the swellable particulates are provided in a first region of the fracture towards a fracture tip and the proppants are provided in a second region of the fracture between the first region and the wellbore; and
swelling the swellable particulates to create a fluid barrier or restriction in the first region of the fracture.

Another aspect of the present disclosure relates to a method for creating a region of stress in a geological formation surrounding a fracture in the geological formation, comprising:
delivering a first media into the wellbore and into a fracture in the geological formation, the first media comprising a plurality of swellable particulates comprising a swellable material configured to volumetrically swell in response to exposure to a swelling activator;
delivering a second media into the wellbore and into the fracture in the geological formation, the second media being different to the first media and comprising a plurality of proppants,
wherein the first media is delivered ahead of the second media such that the swellable particulates are provided in a first region of the fracture towards a fracture tip and the proppants are provided in a second region of the fracture between the first region and the wellbore; and
swelling the swellable particulates to create a region of stress in the formation surrounding the first region of the fracture.

Another aspect of the present disclosure relates to a method for performing a hydraulic fracturing process on a geological formation, the method comprising:
delivering a first media into a wellbore, the first media comprising a plurality of swellable particulates comprising a swellable material configured to volumetrically swell in response to exposure to a swelling activator,
delivering a second media into the wellbore, the second media being different to the first media and comprising a plurality of proppants; and
diverting the first and second media from the wellbore into the formation at a pressure that exceeds a fracture pressure of the formation to create a fracture in the formation,
wherein the first media is delivered ahead of the second media such that the swellable particulates are provided in a first region of the fracture towards a fracture tip and the proppants are provided in a second region of the fracture between the first region and the wellbore.

It will be appreciated that features described in relation to one aspect may be equally combined with any other aspect described herein.

### BRIEF DESCRIPTION OF THE DRAWINGS

These and other aspects of the present disclosure will now be described, by way of example only, with reference to the accompanying drawings, in which:

FIGS. 1 to 3 provide a schematic illustration of a method for treating a geological formation;

FIGS. 4 and 5 are schematic illustrations of first and second media being into the wellbore;

FIG. 6 is a schematic illustration of a fracture tip comprising swellable particulates;

FIG. 7 is a schematic illustration of a fracture tip comprising swellable particulates and fibre elements;

FIGS. 8 and 9 are schematic illustrations of a wellbore that has been subject to a treatment process;

FIG. 10 is a schematic perspective view of multiple horizontal wells;

FIG. 11 is an example pumping schedule for use in a method for treating a geological formation; and

FIGS. 12 and 13 are images taken from a laboratory test performed by the present inventors demonstrating plugging effects with and without fibre elements; and

FIG. 14 is a summary chart of the laboratory tests.

### DETAILED DESCRIPTION OF THE DRAWINGS

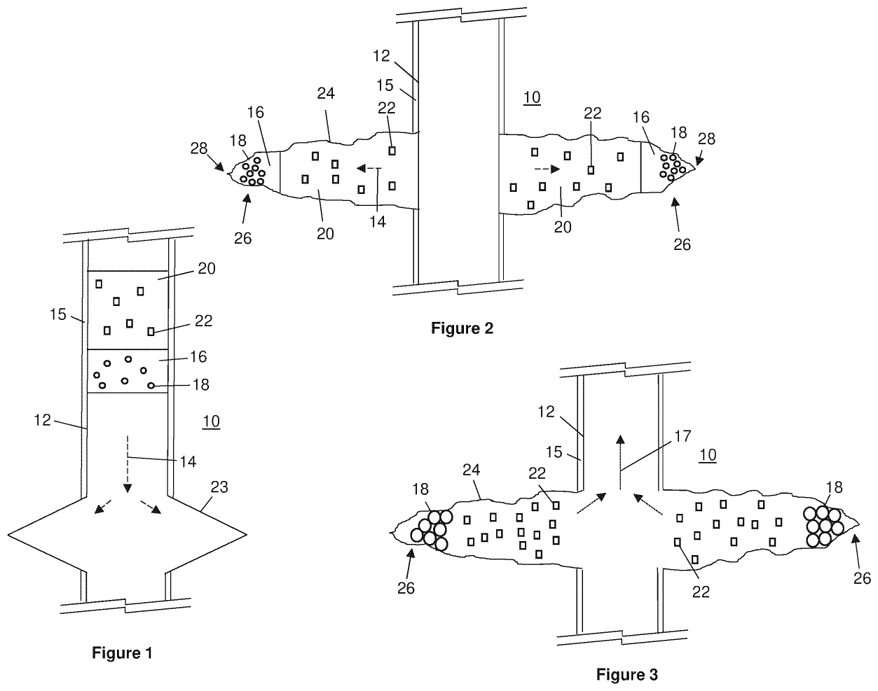

FIGS. 1 to 3 provide a schematic illustration of a method for treating a geological formation 10. Multiple applications may be possible and may facilitate treatment of a geological formation for various purposes, such as to improve the efficiency of extraction of hydrocarbons or geothermal heat. However, for the purposes of providing an exemplary application, the following description generally relates to a hydraulic fracturing process for the extraction of hydrocarbons.

FIG. 1 schematically illustrates first and second media being transported through a wellbore 12 in a downhole direction 14. The first media comprises a first carrier fluid 16 and a plurality of swellable particulates 18, and the second media comprises a second carrier fluid 20 and a plurality of proppants 22. A plug (not shown) may be set below a perforation 23 formed in casing 15 in the wellbore 12 to direct the first and second media from the wellbore 12 towards the formation 10. Referring to FIG. 2, the first and second media have been delivered into the wellbore 12 at a pressure that exceeds a fracture pressure of the formation 10 to create a fracture 24 in the formation 10. The first media is delivered into the wellbore 12 and into the fracture 24 ahead of the second media such that the swellable particulates 18 are provided in a first region of the fracture 24 towards a fracture tip 26, and the proppants 22 are provided in a second region of the fracture 24 between the first region and the wellbore 12.

The swellable particulates 18 volumetrically swell in the first region of the fracture 24 towards the fracture tip, providing a number of preferential functions. For instance, when the swellable particulates 18 are in a swelled condition they may create at least a partial fluid barrier or restriction in the first region, which may prevent or delay unwanted fluids (such as water which has migrated from neighbouring zones in the formation 10) from entering the fracture 24. Furthermore, a compressive force may be exerted on the formation 10 as the swellable particulates 18 volumetrically swell, creating a region of localised stress around the fracture tip 26. Without wishing to be bound by theory, it is believed that the region of localised stress in the formation 10 may discourage other fractures from extending towards this region, thus reducing the likelihood of fractures from different wells connecting with one another.

The fracture 24 may vary in cross-sectional area along a length of the fracture 24, with the facture tip 26 having a smaller area than a main body of the fracture 24. The swellable particulates 18 may be configured to bridge with one another in the first region of the fracture 24 towards the fracture tip 26, at a distance from an outermost point 28 of the fracture 24. Bridging occurs where particulates of a certain size simultaneously arrive at a constriction in a flow path and form a bridge or arch across the constriction, thereby obstructing the flow path and preventing further particulates from travelling past the constriction. In this regard the swellable particulates 18 may comprise a certain shape or size based on expected fracture dimensions (which for example may have been obtained by performing hydraulic fracturing simulations) to provide bridging of the swellable particulates 18 towards the fracture tip 26. In this example, the swellable particulates 18 may comprise a granular form having a grain size distribution between 10 and 400 mesh, which may in addition help effectively transport the swellable particulates 18 through the wellbore 12 and into the fracture 24.

The swellable particulates 18 are configured to volumetrically swell in response to exposure to a swelling activator (e.g. water) by osmosis. The proppants 22 may be any suitable proppant known in the art, such as ceramics, sand, glass, plastics, etc., and may be substantially non-swellable.

The carrier fluids 16, 20 may be any suitable fluid, such as a fluid used in a hydraulic fracturing process. The carrier fluids 16, 20 may be the same fluid or a different fluid. The first and second carrier fluids 16, 20 may comprise a water-based fluid, which may in some cases cause the swellable particulates 18 to partially swell as the swellable particulates 18 are transported through the wellbore 12. Therefore, to prevent premature swelling of the swellable particulates 18, the swellable particulates 18 may comprise a coating configured to degrade at a predetermined stage in the treatment process, such as when reaching the first region of the fracture 24. Alternatively, or in addition, the swellable particulates 18 may be configured to swell at a certain swell rate when exposed to the swelling activator to prevent the swellable particulates 18 from swelling to an undesirable extent prior to reaching the fracture 24.

In FIG. 3, the carrier fluids 16, 20 have been displaced from the fracture 24 while the swellable particulates 18 and proppants 22 have been retained in the first and second regions of fracture 24, respectively. After exposure to a certain amount of the swelling activator, the swellable particulates 18 have volumetrically swelled into a swelled condition (which condition may be when the swellable particulates 18 have increased by at least 10% of their completely unswelled size). In this example, the swellable particulates 18 are configured to swell between 10 and 400% of their completely unswelled size, however this may vary depending on the application. When the swellable particulates 18 and proppants 22 have been provided first and second regions of the fracture 24, respectively, hydrocarbons 17 flow from the geological formation 10 into the wellbore 12 via the fracture 24 for production at surface.

The swellable particulates 18 comprise a material configured to provide a desired swell strength, longevity under downhole conditions, and/or chemical resistance. The swellable particulates 18 may be configured to retain the swelling activator, once absorbed, to remain in the swelled condition for a perceived operational lifetime of the swellable particulates. This may be based on an operational lifetime of the well (e.g. from production to abandonment), the expected operational lifetime of a reservoir associated with the well, or the expected operational lifetime of a neighbouring well (such as, an infill well), etc. The swellable particulates 18 may be non-degradable in the sense that they may be configured to withstand exposure to certain substances that the swellable particulates 18 may encounter during their operational lifetime. In this regard the swellable particulates 18 may be considered as permanent. In some examples, a density of the swellable particulates 18 may be modified to promote settling of the swellable particulates 18 at a low or high side of the fracture 24.

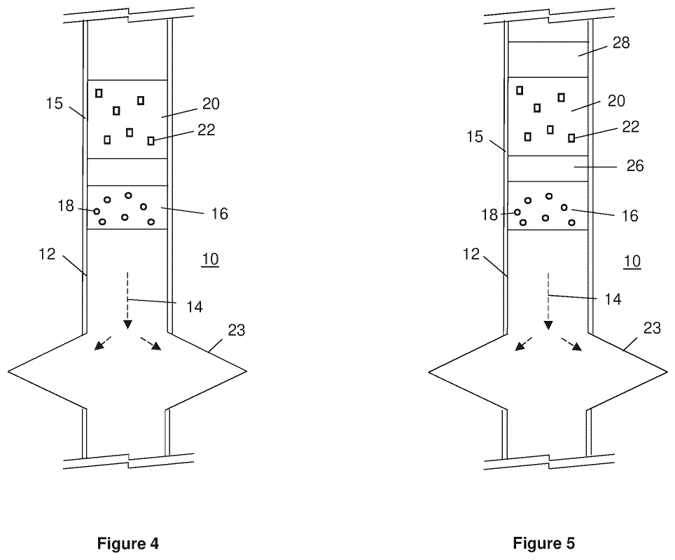

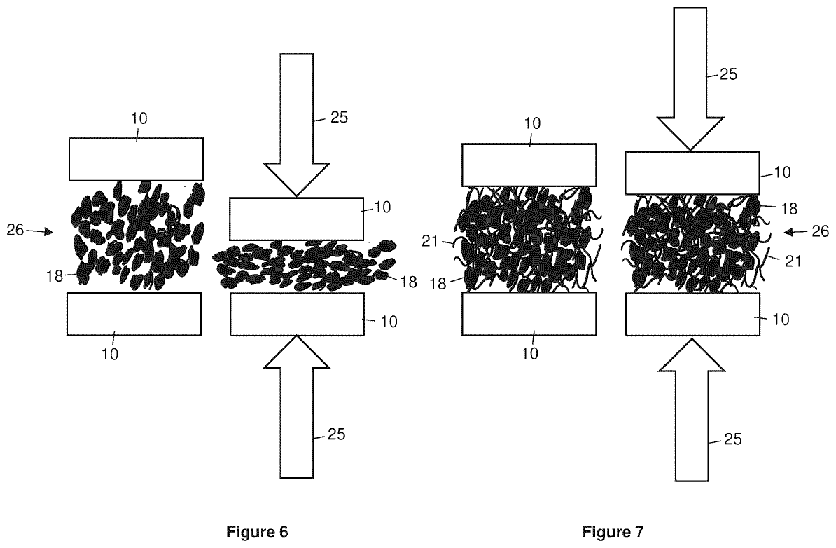

FIGS. 4 and 5 are schematic illustrations of the first and second media being transported through the wellbore 12. In FIG. 4, the second media has been delivered into the wellbore 12 a certain time after the first media. For example, the first media may be delivered into the wellbore 12 before a proppant stage of a hydraulic fracturing process (for example as, or as part of, a preliminary injection test). The second media may be delivered into the wellbore 12 during the proppant stage. Alternatively, or in addition, the first media may be delivered into the wellbore 12 during the start or early stages of the proppant stage, with the second media being delivered into the wellbore 12 immediately after.

In the example of FIG. 5, the first and second carrier fluids 16, 20 do not comprise the swelling activator. Instead, a swelling activator 28 has been delivered into the wellbore 12 sometime after the first and second media have been delivered into the wellbore 12. For example, the swelling activator 28 may be delivered into the wellbore 12 as part of a flush stage in a hydraulic fracturing treatment. Alternatively, the method may comprise utilising a swelling activator present in the formation 10 and exposing the swellable particulates 18 to the swelling activator in the formation 10. A buffer fluid 26 may be delivered into the wellbore 12 intermediate the first and second media, which may help to maintain the first media separate from the second media.

The first media may comprise fibre elements 21 mixed together with the swellable particulates 18. The fibre elements 21 may be configured to comprise or exhibit a selectively adhesive characteristic, which may be temperature or chemically activated. Once activated, the fibre elements 21 may create a web arrangement with one another in the fracture for constraining movement of the swellable particulates, which may prevent the swellable particulates 18 from moving to a more dispersed, relaxed position during and after the swelling process. This may help maximize the fluid barrier created and the resulting stress concentration in the formation 10. As schematically illustrated in FIG. 7, once the carrier fluid has been displaced from the fracture tip 26 and the formation 10 acts on the swellable particulates 18 with a compressive force in the direction of arrows 25, the fibre elements 21 may help maintain the swellable particulates 18 in place at the fracture tip 26.

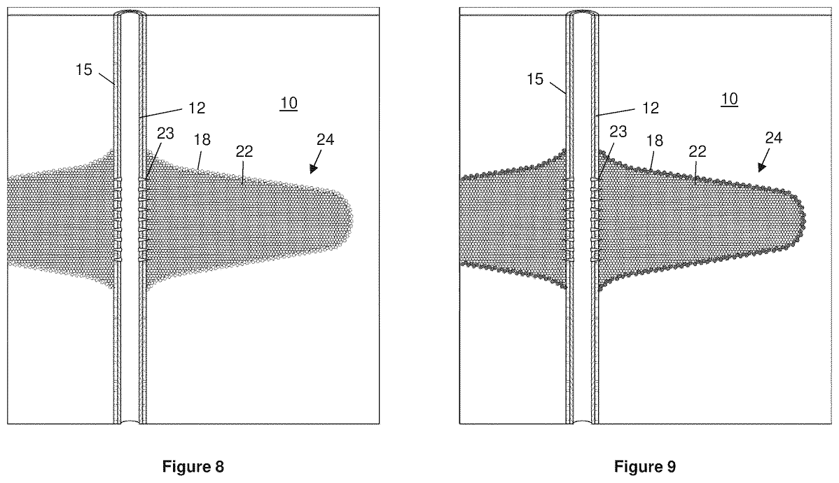

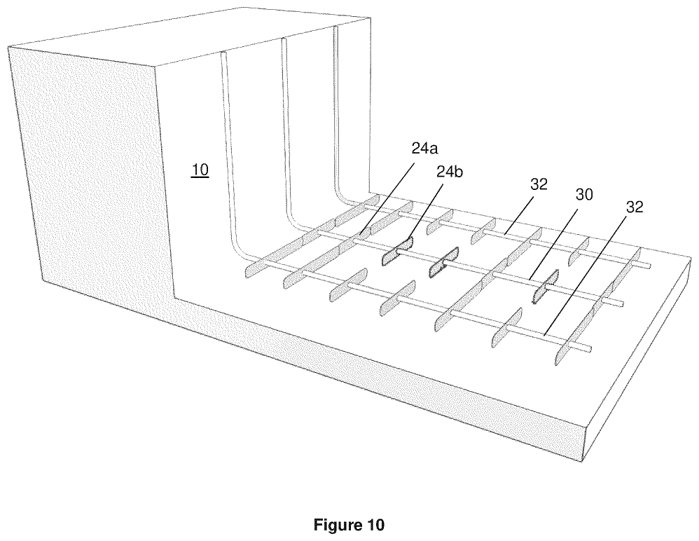

FIGS. 8 and 9 are schematic illustrations of a wellbore 12 that has been subject to a treatment process in accordance with the present disclosure. The wellbore 12 comprises a plurality of perforations 23 through which multiple fractures 24 have been created. Swellable particulates 18 have been provided in regions towards the fracture tips 26 of each fracture 24, and proppants 22 have been provided in regions of the fractures 24 between the fracture tips 26 and the wellbore 12. The swellable particulates 18 are illustrated in unswelled and swelled conditions in FIGS. 8 and 9, respectively.

FIG. 10 is a schematic perspective view of a number of adjacent wellbores. In particular, FIG. 10 represents a possible comparison between fractures 24a of a well 30 that do not include swellable particulates 18 and fractures 24b of the well 30 that do include swellable particulates 18. Here, the fractures 24a that include the swellable particulates 18 have created regions of localised stress in the formation 10 around the fractures 24a, which may discourage other fractures 32 from extending towards these regions.

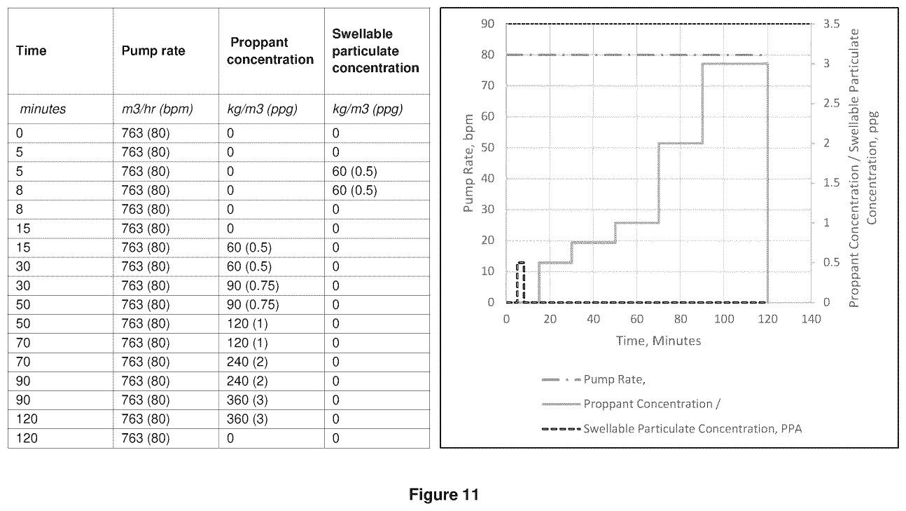

FIG. 11 illustrates one example of a pumping schedule for use in the method referred to above. In this example, the first and second carrier fluids 16, 20 comprise the same fluid and are therefore, for the sake of convenience, both referred to as carrier fluid in the following description.

At t=0, pumping of the carrier fluid into the wellbore is initiated at a constant rate of 763 m³/hr (80 barrel oil per minute (bpm)). At t=5 min, the swellable particulates 18 are injected or incorporated into the flow of carrier fluid to provide the first media for delivering into the wellbore. The rate of injection or incorporation of swellable particulates 18 in the carrier fluid is provided such that from t=5 to 8 min, a concentration of swellable particulates in the carrier fluid (i.e. a mass of swellable particulates per volume of carrier fluid) is 60 kg/m³ (0.5 ppg). At t=8 min, the injection or incorporation of swellable particulates 18 into the carrier fluid is ceased, and from t=8 to 15 min the carrier fluid is continued to be pumped into the wellbore at the rate of 763 m³/hr (80 bpm), thus providing the buffer fluid 26 illustrated in the example of FIG. 5. At t=15 min, the proppants 22 are injected or incorporated into the flow of carrier fluid to provide the second media for delivering into the wellbore. The rate of injection or incorporation of proppants 22 in the carrier fluid is varied over time, such that from t=15 to 30 min a concentration of proppants in the carrier fluid is 60 kg/m³ (0.5 ppg), from t=30 to 50 min the concentration of proppants is 90 kg/m³ (0.75 ppg), from t=50 to 70 min the concentration of proppants is 120 kg/m³ (1 ppg), from t=70 to 90 min the concentration of proppants is 240 kg/m³ (2 ppg) and from t=90 to 120 min the concentration of proppants is 360 kg/m³ (3 ppg). At t=120 min, the pumping of carrier fluid is ceased and the pumping schedule is complete.

The present inventors performed laboratory testing in which a TWC-06 rubber sample (representing a mass of swellable particulates) was placed into a metal housing and allowed to swell in fresh water for 6 days at 110° C. The rubber sample achieved 89% swelling of its initial unswelled volume after the 6 days elapsed. Pressure was then applied to the rubber sample while in the metal housing using a 20 tonne load cell to record the load applied. The amount of compression of the rubber sample was measured at 20% from its swelled volume (89% of its unswelled volume) and a maximum pressure of around 23 MPa (3300 psi) was recorded. Applying these results in context, a typical virgin stress for a 2400 m (8000 ft.) well with normal faulting may be in the order of 33 MPa (4800 psi). Thus, the laboratory testing suggests that the stress produced by further compression of the swellable particulates inside the fracture could be at least comparable to the initial in-situ stress and may exceed this over time during pore pressure depletion.

In addition, the present inventors performed laboratory testing demonstrating the plugging effects obtainable with and without fibre elements. In particular, a slotted test apparatus was provided and a piston cylinder was used to deliver a slurry mixture of water and swellable particulates (and, depending on the test performed, fibre elements) into a slot of the test apparatus. The piston cylinder included a sample chamber for receiving the slurry mixture and a pressure chamber for receiving pressurised gas to drive a piston to displace the slurry mixture from the sample chamber and into the slotted test apparatus. A valve was provided for opening and closing a flow path from the slotted test apparatus.

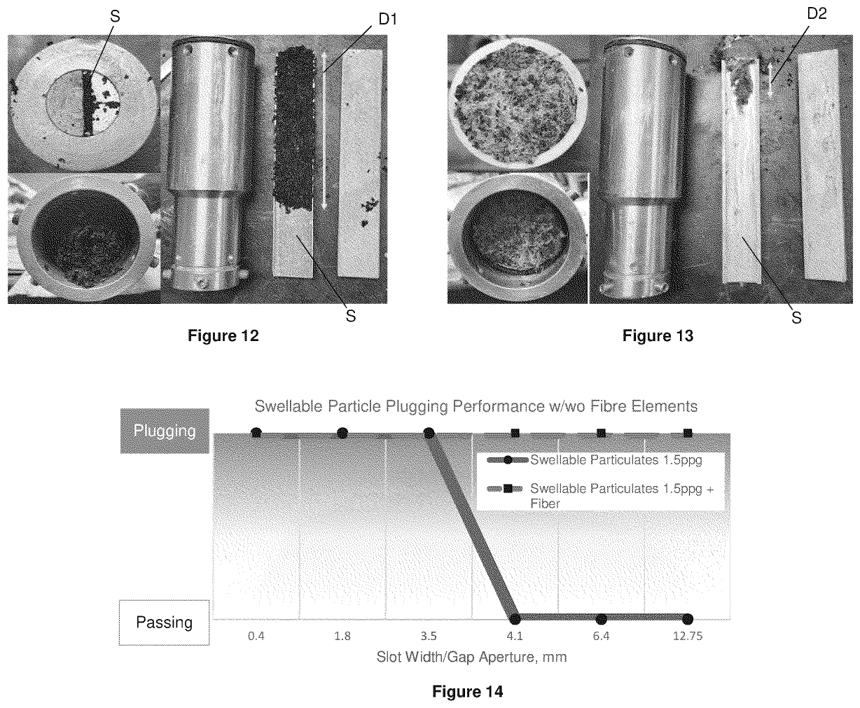

The test method comprised mixing one litre of water with 60 grams of swellable particulates (i.e., 0.5-1.5 lbs per gallon (0.06-0.18 g/ml) equivalent concentration) to provide a slurry mixture. The slurry mixture was delivered into the sample chamber and a pressure inside the pressure chamber was increased up to a pressure threshold of 50 psi (345 kPa). The valve was then opened and the slurry displaced through the slot of the slotted test apparatus was recorded every 15 seconds until the sample chamber had emptied. If the sample chamber had not emptied at 50 psi (345 kPa), the pressure inside the piston chamber was then increased in 50 psi (345 kPa) increments up to 200 psi (1.38 MPa), and the pressure at which plugging integrity was lost was recorded. The present inventors repeated the above tests for a slurry mixture also comprising temperature-activated fibre elements. FIGS. 12 and 13 are images taken from the slotted test apparatus after the tests described above had been performed, with and without fibre elements, respectively.

The size distribution for the coarse size of the swellable particulates used in the laboratory testing is provided in Table 1 below.

TABLE 1

| Microns | wt (g) | diff % | cum % |
|---|---|---|---|
| 710 | 17.6 | 88.9 | 88.9 |
| 500 | 0.4 | 1.9 | 90.8 |
| 355 | 0.3 | 1.5 | 92.3 |
| 250 | 0.3 | 1.4 | 93.7 |
| 180 | 0.29 | 1.5 | 95.2 |
| 150 | 0.13 | 0.7 | 95.9 |
| 90 | 0.33 | 1.7 | 97.5 |
| 70 | 0.09 | 0.5 | 98 |
| pan | 0.4 | 2 | 100 |

FIG. 12 shows the results of the test performed without fibre elements. The slotted test apparatus was set up to provide the slot S with a width of 4 mm. A slurry mixture with a concentration of 1.5 ppg (0.18 g/ml) of swellable particulates was used. As shown by the distance D1, which illustrates the length through the slot which the swellable particulates travelled before bridging, the amount of material lost through the slotted test apparatus is substantial. In practical terms, this would mean a large volume of material is required to provide a plug and seal across a fracture having similar dimensions. FIG. 13 shows the results of the test performed with the same 1.5 ppg (0.18 g/ml) mixture of swellable particulates but with the addition of the temperature-activated fibre elements. The fibre elements were added to the slurry mixture in a concentration of 3% by weight of swellable particulates. As illustrated by the distance D2, under the same slot testing conditions, a plug is formed very early on bridging the slot and limiting the loss of material. Therefore, the laboratory tests demonstrate that the fibre elements provide for improved consolidation of the slurry.

In practical terms, these results show that the addition of the fibre elements can improve bridging and reduce the amount of material required to create a robust plug and seal. A summary chart of the plugging results with and without fibre elements for different slot widths is illustrated in FIG. 14, which shows that the plugging potential of a given swellable particulate distribution can be extended with the addition of temperature-activated fibre elements. In particular, FIG. 14 illustrates the slot width at which seal integrity was lost when tested at pressures of around 200 psi (1.38 MPa). As can be seen, for slurry mixtures not comprising fibre elements, the seal integrity was lost at a slot width of 4.1 mm, only slightly above the 4 mm test described above. The slurry mixture comprising fibre elements, however, was able to maintain seal integrity up to a maximum slot width of the apparatus, 12.75 mm.

It is intended that the fibre elements bond to each other creating a web which promotes plugging of swellable particulates in higher slot widths. This enables the swellable particulates to seal larger loss zones. As such, the web formed by the fibre elements may substantially help improve the plugging performance under downhole conditions. As described hereinabove, in some examples, the fibre elements may not be activated at surface temperatures and conditions and therefore can be easily prepared and pumped using standard surface equipment and passing through pipework and completion restrictions. This same approach can be applied to a range of particle size distributions to enhance the bridging tendency and plugging potential in larger slots and in field applications for induced/natural fractures, vugs and intervals with substantial losses.

1. A method for treating a geological formation surrounding a wellbore, comprising:
delivering a first media into the wellbore and into a fracture in the geological formation, the first media comprising a plurality of swellable particulates comprising a swellable material configured to volumetrically swell in response to exposure to a swelling activator; and
delivering a second media into the wellbore and into the fracture in the geological formation, the second media being different to the first media and comprising a plurality of proppants,
wherein the first media is delivered ahead of the second media such that the swellable particulates are provided in a first region of the fracture towards a fracture tip and the proppants are provided in a second region of the fracture between the first region of the fracture and the wellbore.

2. The method of claim 1, comprising flowing a formation product from the geological formation through the fracture with the swellable particulates in the first region of the fracture.

3. The method of claim 2, wherein the formation product comprises hydrocarbons or a geothermal fluid.

4. The method of claim 1, wherein the swellable particulates are non-degradable.

5. The method of claim 1, wherein the swellable particulates are configured to be substantially unaffected by substances the swellable particulates are expected to encounter during their operational lifetime

6. The method of claim 1, wherein at least one of the first and second media is delivered into the wellbore at a pressure that exceeds a fracture pressure of the formation to create the fracture in the geological formation.

7. The method of claim 1, wherein the swellable particulates comprise a coating configured to degrade after a certain duration of time.

8. The method of claim 1, wherein the swellable particulates are configured to swell at a certain swell rate in response to exposure to the swelling activator to provide the swellable particulates in a swelled condition after a certain duration of time.

9. The method of claim 1, comprising forming a bridge with at least a portion of the swellable particulates in the first region of the fracture.

10. The method of claim 1, wherein the first media comprises a first carrier fluid, and the second media comprises a second carrier fluid.

11. The method of claim 10, wherein the first and second carrier fluids are or comprise the same or different fluids.

12. The method of claim 1, comprising delivering a buffer fluid into the wellbore intermediate the first media and the second media.

13. The method of claim 1, wherein the first media is delivered into the wellbore at a first pressure and the second media is delivered into the wellbore at a second pressure.

14. The method of claim 13, wherein the first and second pressures comprise the same or different pressures.

15. The method of claim 1, wherein the first media is delivered into the wellbore at a first flowrate and the second media is delivered into the wellbore at a second flowrate.

16. The method of claim 15, wherein the first and second flowrates comprise the same or different flowrates.

17. The method of claim 1, wherein the first and second media are delivered into the wellbore as part of a hydraulic fracturing process.

18. The method of claim 17, wherein the first media is delivered into the wellbore as, or as part of, a preliminary injection test.

19. The method of claim 1, comprising, prior to performing the first step of delivering the first media into the wellbore and into the fracture, delivering a third media into an adjacent fracture in the geological formation, the third media comprising a plurality of swellable particulates configured to volumetrically swell in response to exposure to a swelling activator.

20. The method of claim 1, wherein the swellable particulates are configured to remain in a swelled condition for a perceived operational lifetime.

21. The method of claim 1, wherein the swelling particulates are configured to swell between 10 and 400% of their completely unswelled size.

22. The method of claim 1, wherein the swelling activator is at least one of water and oil.

23. The method of claim 1, wherein the swellable particulates are configured to swell by osmosis.

24. The method of claim 10, wherein at least one of the first and second carrier fluids comprise the swelling activator.

25. The method of claim 1, comprising exposing the swellable particulates to the swelling activator after the swellable particulates have been provided in the first region of the fracture.

26. The method of claim 1, wherein the swellable particulates comprise a grain size distribution between 10 and 400 mesh.

27. The method of claim 1, wherein the first media comprises a plurality of fibre elements.

28. The method of claim 27, wherein the fibre elements are configured to adhere to one another to create a web arrangement for constraining movement of the swellable particulates in response to exposure to an adhesion activator.

29. The method of claim 27, wherein the adhesion activator is defined by an activation temperature.

30. The method of claim 27, wherein the fibre elements comprise a core-shell configuration.

31. The method of claim 27, wherein a weight of the fibre elements in the first media is in a range from 0.5% to 10% of the total weight of swellable particulates in the first media.

32. The method of claim 1, wherein delivering the first and second media into the wellbore comprises pumping the first and second media into the wellbore.
